(19) United States
(12) Patent Application Publication
(10) Pub. No.: US 2024/0320603 A1
(43) Pub. Date: Sep. 26, 2024

(54) A SYSTEM AND A METHOD FOR FINDING A TARIFF CODE

(71) Applicant: Raveendra Purushottam PETHE, Pune (IN)

(72) Inventor: Raveendra Purushottam PETHE, Pune (IN)

(21) Appl. No.: 18/578,027

(22) PCT Filed: Jul. 18, 2022
(86) PCT No.: PCT/IB2022/056572

§ 371 Date: Jan. 10, 2024

(30) Foreign Application Priority Data
Jul. 17, 2021 (IN) 202121032261

(51) Int. Cl. G06Q 10/0831; G06F 16/38

(52) U.S. Cl. CPC G06Q 10/0831; G06F 16/38

(57) ABSTRACT

The present disclosure discloses a system (100) for finding a tariff code. The system (100) includes a server (102) implementing a web-based platform having a framework (102a) and repository (102b). The server (102) includes a user interface (104) to receive user inputs from a user application running on a computing device, an admin interface (106) manage and validate user details to generate login credentials; a login module (108) to enable the user to login to an account; an input module (110) to allow the user to select an enquiry form and submit enquiry form; a crawler and extractor module (112) to crawl through a list of questions stored and extract questions based on the enquiry form; a display module (114) display response; a response analyzer (116) to analyze the responses provided by the user and prompt the user to upload a relevant media; an uploading module (118) to upload the relevant media; and an HS code finder (120) to find the HS code with information.

### FIELD OF INVENTION

The present disclosure generally relates to a tariff code finder. More particularly, the present disclosure relates to systems and methods for finding a tariff code.

### Definitions

As used in the present disclosure, the following terms are generally intended to have the meaning as set forth below, except to the extent that the context in which they are used, indicates otherwise.

HS/HSN code—The term “HS/HSN code” hereinafter refers to a six-digit uniform code developed by the World Customs Organization called, ‘Harmonized System of Nomenclature’ (′HS/HSN′) for referring goods in international trade. More than five thousand such numeric codes are issued by the WCO and adopted by the member countries and businesses.

Questionnaire—The term “Questionnaire” hereinafter refers to a Question bank, a list of questions, a list of questionnaire, a questionnaire list.

### BACKGROUND

The background information herein below relates to the present disclosure but is not necessarily prior art.

In many large consulting firms, indirect tax professionals are having lead expertise in classification matters. Though, these may not have a dedicated team in this area alone. Except for the search engines available on the internet, presently, there is no known solution in the public domain, based on information technology.

For example, an international business entity considering manufacturing a new product may explore the prevailing rate of customs duties for the raw materials in a country, in which they propose to establish a plant for such manufacture. To start with, in any such kind of exploration, business entities spread over many countries are required to arrive at a common understanding of the classification of products before attempting further analysis. Industry experts are thus in dire need of tools that go beyond the textual searches provided in websites and offline databases.

Growth in international trade, as well as countries implementing new age GST/VAT, has led to a wide number of people understanding and using HS (Harmonized System) for perceiving the local GST/VAT or customs tariffs, respectively. A real-time classification service for businesses all over the world is in want. The advantages of HS code if followed correctly could go far beyond what is perceived today. The HS-based codes cross language and cultural barriers while understanding the goods, cargo, merchandise, supplies, products, etc.

The regulatory environment and logistical needs have enhanced the dependency on the correct determination of HS code. It is now a mandatory maritime requirement to submit an HS code in the shipping instruction while merely passing over a port. For example, the port authorities in Belgium require berthed vessels to declare cargo in their hold using HS, even if the shipment is not destined to that country. Such information on HS codes may be useful for understanding the hazardous nature of cargo in case of spillage or pilferage. HS codes conveniently give out the chemical composition (inflammable, radioactive, narcotic, etc.) for making out environmental or security concerns by the captains of ships, shippers, and port authorities around the globe.

Of late, more and more organizations are required to review the existing classification codes for mistakes. This is a humongous task for large corporate entities whose inventories contain thousands and lakhs of individual items spread over multiple economies. The precise information about the products required to determine classification is possessed by the technical people in an organization whereas the requirement to determine it from a tax, or regulatory compliance perspective is with the commercial people in a given organization. Determining precise HS code is the most challenging job and therefore it becomes a time-consuming activity that makes it difficult for staff from different verticals to come together and spend substantial time. Moreover, when such requisite information is collected for determining classification, the history of such reporting may not be traceable for posterity, Therefore, on an exceptional basis, the task of searching tariff code is vested with third-party specialists which invites huge costs.

Therefore, there is a need for a tariff code finder that alleviates the aforementioned drawbacks.

### Objects

Some of the objects of the present disclosure, which at least one embodiment herein satisfies, are as follows:

It is an object of the present disclosure to overcome one or more problems of the prior art or to at least provide a useful alternative.

An object of the present disclosure is to provide a tariff code finder.

Another object of the present disclosure is to provide a finder that is easy to implement.

Yet another object of the present disclosure is to provide a finder that prevents time loss and penalties in searching for the correct code.

Still another object of the present disclosure is to provide a finder that collects and displays the precise information according to the product.

Such object of the present disclosure is to provide a finder that collects information from competent or relevant resources working from home or anywhere.

Such object also encompasses a software module for enabling a number of such competent resources to log into the software remotely and provide a quote for consultancy over tariff research and provide such consultancy through same software.

Another object of the present disclosure is to provide a finder that helps search for the code as per the country, language, and different names of a particular commodity, goods, or shipment of merchandise.

Yet another object of the present disclosure is to provide a finder that helps with avoiding the misclassified entry of goods.

Still another object of present disclosure is to store and provide such details about the collection of requisite information of product under examination as may be possible, commensurate with changing technology and demanded.

Yet another object of present disclosure is to received payment from a remotely logged-in user and also cause payment to the remotely logged-in resource/consultant in real-time.

Other objects and advantages of the present disclosure will be more apparent from the following description when read in conjunction with the accompanying figures, which are not intended to limit the scope of the present disclosure.

### SUMMARY

The present disclosure envisages a system for finding a tariff code. The system includes a server, a framework, a repository, a user interface, an admin interface, a login module, a crawler and extractor module, a display module, a response analyzer, an uploading module, and an HS code finder, and further country-wise codes finder.

The server implements a web-based platform with a framework and a repository. The framework includes a questionnaire form, a user profile, a company profile, and an enquiry form.

The user interface is configured to receive user inputs from a user application running on a computing device of a user.

The admin interface is configured to manage and validate a user account and the related questionnaire form based on the user inputs, so as to generate login credentials for the user. In an aspect, the user and the consultant user accounts can be an individual account or a company account. The main user and/or the admin can create login credentials for additional users.

The login module is configured to enable the user to log in to an account using the login credentials. New user can self-login using a mailed OTP before creating a profile.

The input module is configured to cooperate with the login module to allow the user to select an enquiry form and submit the enquiry form using an interface of the user account.

The crawler and extractor module is configured to cooperate with the input module to crawl through a list of questions stored in the repository and extract the questions from the repository based on the enquiry form selected by the user.

The display module is configured to cooperate with the crawler and extractor module and the input module to display at least one response pertaining to each of the extracted questions on the user interface.

The response analyzer is configured to analyze the responses provided by the user, select a next set of questions from the repository based on the responses or prompt the user to upload relevant media based on the responses.

The uploading module is configured to cooperate with the response analyzer to upload the relevant media, including relevant text, product literature, and a photo of the packaging, of the good for which a Harmonized System (HS) code is to be retrieved from the repository and/or with comments of the chosen expert resource.

The HS code finder is configured to cooperate with the uploading module and the response analyzer to find the HS code with information based on the responses provided by the user and the relevant media uploaded by the user.

In an embodiment, the system comprises a framework. The framework includes a user module and an admin module. The user module is configured to manage an account login control, a user profile edit, designations, user details, the questionnaire form, a report generator, a report viewer, consultant details, a payment gateway, and agreement and terms.

The admin module is configured to manage an account login control, a user account, designations, the questionnaire form, a questionnaire maker, a report generator, consultant details, a biller, a payment gateway, an agreement, and a terms maker.

In an embodiment, the computing device of the user is a device selected from one of a mobile device, a laptop, a tablet, and a desktop system.

In an embodiment, the repository is configured to store a list of pre-stored questions, consultant details, and the question bank.

In an embodiment, the user selects an option from the set of a questionnaire consisting of a multiple-choice question, a single response question, and a set of questions and subsequent sub-questions.

In an embodiment, the system continues the analyses of the responses and the uploaded relevant media till a correct HS code is retrieved from the repository and displayed on the display module.

The present disclosure also envisages a method for finding a tariff code, wherein the method being carried out by a server implementing a web-based platform having the framework and repository, wherein the framework has questioner form, user profile, company profile, enquiry form. The method comprises the following steps:
receiving, by a user interface, user inputs from a user application running on a computing device of a user;
managing, by an admin interface, a user account and a questionnaire form based on the user inputs;
validating, by the admin interface, the user account and the questionnaire form based on the user inputs for generating login credentials for the user;
enabling, by a login module, the user to login to an account using the login credentials;
receiving, by an input module, an input from the user to select and submit an enquiry form through an interface of the user account;
crawling, by a crawler and extractor, through a list of questions stored in the repository and extracting the questions from the repository based on the enquiry selected by the user,
displaying, by a display module, at least one response pertaining to each of the extracted questions on the user interface,
analyzing, by a response analyzer, the responses provided by the user for the extracted questions, select the next set of questions from the repository based on the response for receiving further responses from the user or prompt the user to upload a relevant media,
uploading, by an uploading module, the relevant media, including a relevant text, product literature, and a photo of the packaging, of a good for which a Harmonized System (HS) code is to be retrieved from the repository; and
finding, by a code finder, the HS code with information based on the responses provided by the user and the relevant media uploaded by the user.

### BRIEF DESCRIPTION OF THE ACCOMPANYING DRAWING

A system and a method for a tariff code finder of the present disclosure will now be described with the help of the accompanying drawing, in which:

FIG. 1 illustrates a block diagram of the system for finding a tariff code in accordance with an embodiment of the present disclosure;

FIG. 2A and FIG. 2B illustrate a flow chart depicting steps involved in a method for finding a tariff code in accordance with an embodiment of the present disclosure; and

FIG. 3 illustrates an exemplary flow chart of the system for finding a tariff code for non-users

FIG. 4 illustrates an exemplary flow chart of the system for finding a tariff code for post-paid users.

FIG. 5 illustrates an exemplary flow chart of the system for finding a tariff code for pre-paid users.

FIG. 6 illustrates an exemplary flow chart of the system for finding a tariff code in accordance with another embodiment of the present disclosure.

### LIST OF REFERENCE NUMERALS

100—System
102—Server
102a—Framework
102b—Repository
104—User Interface
106—Admin Interface
108—Login Module
110—Input Module
112—Crawler and Extractor Module
114—Display Module
116—Response Analyzer
118—Uploading Module
120—HS Code Finder
200—Method

### DETAILED DESCRIPTION

Embodiments, of the present disclosure, will now be described with reference to the accompanying drawing.

Embodiments are provided so as to thoroughly and fully convey the scope of the present disclosure to the person skilled in the art. Numerous details, are set forth, relating to specific components, and methods, to provide a complete understanding of embodiments of the present disclosure. It will be apparent to the person skilled in the art that the details provided in the embodiments should not be construed to limit the scope of the present disclosure. In some embodiments, well-known processes, well-known apparatus structures, and well-known techniques are not described in detail.

The terminology used, in the present disclosure, is only for the purpose of explaining a particular embodiment and such terminology shall not be considered to limit the scope of the present disclosure. As used in the present disclosure, the forms “a,” “an,” and “the” may be intended to include the plural forms as well, unless the context clearly suggests otherwise. The terms “including,” and “having,” are open-ended transitional phrases and therefore specify the presence of stated features, integers, steps, operations, elements and/or components, but do not forbid the presence or addition of one or more other features, integers, steps, operations, elements, components, and/or groups thereof. The particular order of steps disclosed in the method and process of the present disclosure is not to be construed as necessarily requiring their performance as described or illustrated. It is also to be understood that additional or alternative steps may be employed.

When an element is referred to as being “engaged to,” “connected to,” or “coupled to” another element, it may be directly engaged, connected, or coupled to the other element. As used herein, the term “and/or” includes any and all combinations of one or more of the associated listed elements.

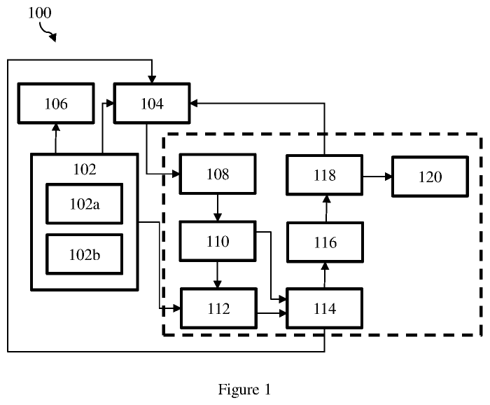

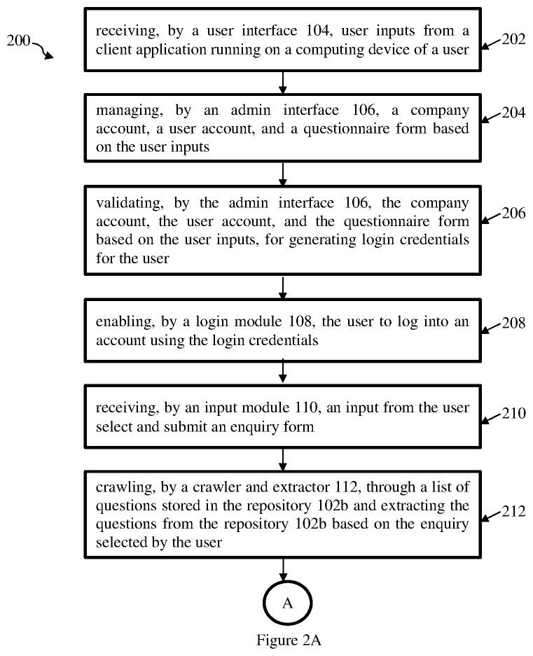

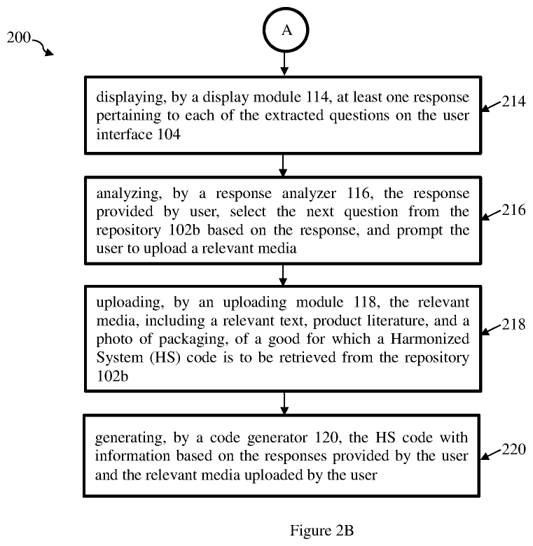

The present disclosure envisages a system (hereinafter referred to as “system 100”) for finding a tariff code and a method for finding a tariff code (hereinafter referred to as “method 200”). The system 100 will now be described with reference to FIG. 1 and the method 200 will be described with reference to FIG. 2A and FIG. 2B.

The HS code referring to any goods by a six-digit code is used by the WTO and several international organizations for international agreements mostly for tax purposes. Governments of participant economies define their own Customs and GST tariff codes broadly based or aligned with the HS. Presently, more than 200 nation economies use the HS-based definitions of products for assigning tax rates and regulatory controls such as issuing concessions, freeing tariffs to their favored neighbors or friendly nations, implementing standards, levying anti-dumping duties, imposing restrictions, or for various other formalities concerning imports or exports in international trade.

The Government of India has legislated the Customs Tariff Act, 1975 for assigning eight-digit codes to determine customs duty rates as per the classification of goods for import or export. A view often accepted at judicial forums is that the heading in the Customs Tariff is pari materia with the heading in the HSN Explanatory Notes and, therefore, they have persuasive value. Additionally, the Indian Import Export Policy has from time to time assigned restrictions and conditions on the import and export of goods with reference to the Indian Tariff Code (Harmonized System). In both the Customs Tariff and in the ITC (HS), the first six digits out of eight digits are aligned with the HS.

For example, TABLE 1 shows the item description and the codes.

TABLE 1

| | Six-digit code as | Eight-digit code as per |
|---|---|---|
| Item description | per HS | Indian Customs tariff |
| Common salt | 2501 00 | 2501 0010 |
| Rock salt | 2501 00 | 2501 0020 |
| Electric car | 8703 10 | 8703 1010 |

In respect of the Indian Customs Tariff, a Section is a group consisting of several Chapters which codify a particular class of goods. The Section Notes explain the scope of Chapters/Headings. The chapters consist of Notes and meanings assigned to terms and descriptions of commodities defined at four-digit, six-digit, or eight-digit levels. A description assigned a four-digit code is termed a ‘heading’. A Heading is branched primarily vide Single Dash (-) which is further sequentially branched under Double Dash (-), Triple Dash (- - -), or Quadruple Dash (- - -) as per requirement. A branch description assigned a six-digit code is termed a ‘subheading’ and the last indivisible 8-digit code is termed a ‘tariff item’ as per the Indian Customs Tariff. The tariff item is assigned a duty rate which is called the tariff rate.

For example, TABLE 2 shows the subheading of the Indian Tariff related to coffee, the descriptions, and the tax rates for the Tariff Items.

TABLE 2

| | | | | Rate |
|---|---|---|---|---|
| Tariff | | | | of |
| Item | | Description | Unit | Duty |
| 0901 | | COFFEE, WHETHER OR NOT | | |
| | | ROASTED OR DECAFFEINATED; | | |
| | | COFFEE HUSKS AND SKINS; | | |
| | | COFFEE SUBSTITUTES | | |
| | | CONTAINING COFFEE IN | | |
| | | ANY PROPORTION | | |
| | - | Coffee, not roasted: | | |
| 090111 | -- | Not decaffeinated: | | |
| | --- | Arabica plantation: | | |
| 09011111 | ---- | A Grade | kg. | 100% |
| 09011112 | ---- | B Grade | kg. | 100% |
| 09011113 | ---- | C Grade | kg. | 100% |
| 09011119 | ---- | Other | kg. | 100% |
| | --- | Arabica cherry: | | |
| 09011121 | ---- | AB Grade | kg. | 100% |
| 09011122 | ---- | PB Grade | kg. | 100% |
| 09011123 | ---- | C Grade | kg. | 100% |
| 09011124 | ---- | B/B/B Grade | kg. | 100% |
| 09011129 | ---- | Other | kg. | 100% |
| | --- | Rob Parchment: | | |
| 09011131 | ---- | AB Grade | kg. | 100% |
| 09011132 | ---- | PB Grade | kg. | 100% |
| 09011133 | ---- | C Grade | kg. | 100% |
| 09011139 | ---- | Other | kg. | 100% |
| | --- | Rob cherry: | | |
| 09011141 | ---- | AB Grade | kg. | 100% |
| 09011142 | ---- | PB Grade | kg. | 100% |
| 09011143 | ---- | C Grade | kg. | 100% |
| 09011144 | ---- | B/B/B Grade | kg. | 100% |
| 09011145 | ---- | Bulk | kg. | 100% |
| 09011149 | ---- | Other | kg. | 100% |
| 09011190 | --- | Other | kg. | 100% |
| 09011200 | -- | Decaffeinated | kg. | 100% |
| | - | Coffee, roasted: | | |
| 090121 | -- | Not decaffeinated: | | |
| 09012110 | --- | In bulk packing | kg. | 100% |
| 09012190 | --- | Other | kg. | 100% |
| 090122 | -- | Decaffeinated: | | |
| 09012210 | --- | In bulk packing | kg. | 100% |
| 09012290 | --- | Other | kg. | 100% |
| 090190 | - | Other: | | |
| 090109010 | --- | Coffee husks and skins | kg. | 100% |
| 09019020 | -- | Coffee substitutes containing coffee | kg. | 100% |
| 09019090 | --- | Other | kg. | 100% |
| 0901 | | COFFEE, WHETHER OR NOT | | |
| | | ROASTED OR DECAFFEINATED; | | |
| | | COFFEE HUSKS AND SKINS; | | |
| | | COFFEE SUBSTITUTES | | |
| | | CONTAINING COFFEE IN | | |
| | | ANY PROPORTION | | |
| | - | Coffee, not roasted: | | |
| 090111 | -- | Not decaffeinated: | | |
| | --- | Arabica plantation: | | |
| 09011111 | ---- | A Grade | kg. | 100% |
| 09011112 | ---- | B Grade | kg. | 100% |
| 09011113 | ---- | C Grade | kg. | 100% |
| 09011119 | ---- | Other | kg. | 100% |
| | --- | Arabica cherry: | | |
| 09011121 | ---- | AB Grade | kg. | 100% |
| 09011122 | ---- | PB Grade | kg. | 100% |
| 09011123 | ---- | C Grade | kg. | 100% |
| 09011124 | ---- | B/B/B Grade | kg. | 100% |
| 09011129 | ---- | Other | kg. | 100% |
| | --- | Rob Parchment: | | |
| 09011131 | ---- | AB Grade | kg. | 100% |
| 09011132 | ---- | PB Grade | kg. | 100% |
| 09011133 | ---- | C Grade | kg. | 100% |
| 09011139 | ---- | Other | kg. | 100% |
| | --- | Rob cherry: | | |
| 09011141 | ---- | AB Grade | kg. | 100% |
| 09011142 | ---- | PB Grade | kg. | 100% |
| 09011143 | ---- | C Grade | kg. | 100% |
| 09011144 | ---- | B/B/B Grade | kg. | 100% |
| 09011145 | ---- | Bulk | kg. | 100% |
| 09011149 | ---- | Other | kg. | 100% |
| 09011190 | --- | Other | kg. | 100% |
| 09011200 | -- | Decaffeinated | kg. | 100% |
| | - | Coffee, roasted: | | |
| 090121 | -- | Not decaffeinated: | | |
| 09012110 | --- | In bulk packing | kg. | 100% |
| 09012190 | --- | Other | kg. | 100% |
| 090122 | -- | Decaffeinated: | | |
| 09012210 | --- | In bulk packing | kg. | 100% |
| 09012290 | --- | Other | kg. | 100% |
| 90190 | - | Other: | | |
| 09019010 | --- | Coffee husks and skins | kg. | 100% |
| 09019020 | --- | Coffee substitutes containing coffee | kg. | 100% |
| 09019090 | --- | Other | kg. | 100% |

Classification code as per HS or as per the national tariff such as the one above for India is useful in the understanding of the following crucial parameters, et al:
Whether the goods are prohibited for import (or export), or allowed, but with restrictions or under a license;
Import duty rate, preferential rate, and other concessions;
Rate of drawback (refund), concessions, duty, cess (tax), etc. on export;
License quotas and country-specific sanctions;
Applicability of standards, requirements of metrology, and markings (on packages);
Dual-use (SCOMET in India); and
Basic identity for logistic and governance purposes

In an exemplary embodiment, the HS code consists of 6-digits for a product. The first two digits designate the HS Chapter. The next two digits differentiate the HS heading under the Chapter. The last set of two digits further differentiates the HS subheading. HS code 1006.30, for example, indicates Chapter 10 (Cereals), Heading 06 (Rice), and Subheading 30 (Semi-milled or wholly milled rice, whether or not polished or glazed). The HS is divided into 21 Sections and 96 Chapters.

Referring to FIG. 1, the system 100 comprises a server 102, a framework 102a, a repository 102b, a user interface 104, an admin interface 106, a login module 110, a crawler and extractor module 112, a display module 114, a response analyzer 116, an uploading module 118, and an HS code finder 120.

The server 102 implements a web-based platform having a framework 102a and a repository 102b. The rein the framework 102a includes a question bank, a user profile, a company profile, and an enquiry form. The server 102 includes:

The user interface 104 is configured to receive user inputs from a user application running on a computing device of a user.

The admin interface 106 is configured to manage and validate a user account and the related questionnaire form based on the user inputs and to generate login credentials for the user.

The login module 108 is configured to enable the user to log in to an account using the login credentials.

The input module 110 is configured to cooperate with the login module 108 to allow the user to select an enquiry form and submit the enquiry form through an interface of the user account.

The crawler and extractor module 112 is configured to cooperate with the input module 110 to crawl through a list of questions stored in the repository 102b and extract the questions from the repository 102b based on the enquiry form selected by the user.

The display module 114 is configured to cooperate with the crawler and extractor module 112 and the input module 110 to display at least one response pertaining to each of the extracted questions on the user interface 104.

The response analyzer 116 is configured to analyze the responses provided by the user for the extracted questions, select a next set of questions from the repository (102b) based on the responses for receiving further responses from the user or prompt the user to upload a relevant media.

The uploading module 118 is configured to cooperate with response analyzer 116 to upload the relevant media, including relevant text, product literature, and a photo of the packaging, of a good for which a Harmonized System (HS) code is to be retrieved from the repository 102b.

The HS code finder 120 is configured to cooperate with the uploading module 118 and the response analyzer 116 to find the HS code with information based on the responses provided by the user and the relevant media uploaded by the user.

FIG. 2A and FIG. 2B illustrate a method 200 for finding a tariff code in accordance with an embodiment of the present disclosure. The order in which the method 200 is described is not intended to be construed as a limitation, and any number of the described method blocks can be combined in any appropriate order to carry out the method 200 or an alternative method. Additionally, individual blocks may be deleted from the method 200 without departing from the scope of the subject matter described herein.

At Step 202, the method 200 includes receiving, by a user interface 104, user inputs from a user application running on a computing device of a user.

At Step 204, the method 200 includes managing, by an admin interface 106, a company account, a user account, and a questionnaire form based on the user inputs.

At Step 206, the method 200 includes validating, by the admin interface 106, the company account, the user account, and the questionnaire form based on the user inputs, for generating login credentials for the user.

At Step 208, the method includes enabling, by a login module 108, the user to log into an account using the login credentials.

At Step 210, the method includes receiving, by an input module 110, an input from the user select and submit an enquiry form.

At Step 212, the method includes crawling, by a crawler and extractor 112, through a list of questions stored in the repository 102b and extracting the questions from the repository 102b based on the enquiry selected by the user.

At Step 214, the method includes displaying, by a display module 114, at least one response pertaining to each of the extracted questions on the user interface 104.

At Step 216, the method includes analyzing, by a response analyzer 116, the response provided by the user, selecting the next question from the repository 102b based on the response, and prompting the user to upload relevant media.

At Step 218, the method includes uploading, by an uploading module 118, the relevant media, including relevant text, product literature, and a photo of the packaging, of a good for which a Harmonized System (HS) code is to be retrieved from the repository 102b.

At Step 220, the method includes finding, by a code finder 120, the HS code with information based on the responses provided by the user and the relevant media uploaded by the user.

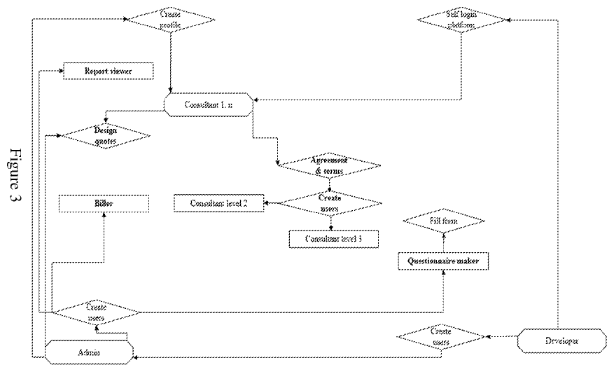

FIG. 3 illustrates an exemplary flow chart of the system for finding a tariff code for non-users.

FIG. 3 describes the functionality of the system for finding a tariff code for non-users, wherein the developer is creating an admin module and admin account and further the admin module is permitted to create other functionality like a biller, report viewer, and questionnaire maker, wherein the biller is used to generate final bill receipt, a questionnaire maker is generated by admin module to add, edit, update the question bank for the questionnaire form generator. The questionnaire form is uploaded and managed by the admin module and the question bank is uploaded in the form by the questionnaire maker. A report viewer module is used to view the complete report generated from the response received from the questionnaire. Further admin module creates the consultant, a set of terms & creates other user levels.

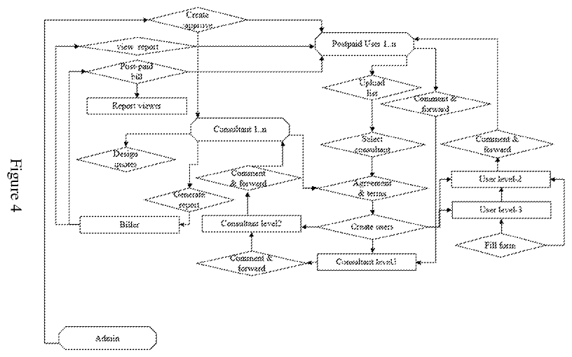

FIG. 4 illustrates an exemplary flow chart of the system for finding a tariff code for post-paid users. FIG. 4 describes the functionality of the system for finding a tariff code for post-paid users, the admin module creates a user. The user login with the credential to the application interface. The user then selects the option to upload the list and select the consultant. Once the user and consultant agree with the terms and create users at level-2 and level-3, wherein level 3 user takes the survey and fills the questionnaire form after level 3 completes the filing questionnaire form the level-2 user comments on the response of the questionnaire form and forward to the top level. After user comments the workflow is passed to the consultant level-3. The workflow received from level-3 passes with comments to level-2 of consultant level-2 comments and forwards to top level of the consultant. The consultant generates a report and the Biller generates the bill and shares the final report with the user.

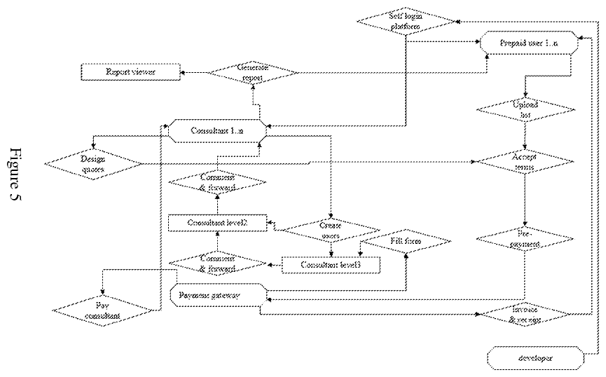

FIG. 5 illustrates an exemplary flow chart of the system for finding a tariff code for pre-paid users. FIG. 5 describes the functionality of the system for finding a tariff code for pre-paid users, wherein the consultant login into the consultant account and create their own profile, and design quotes. Similarly, the pre-paid user login with OTP and uploads the list of products. Further user selects the consultant and agrees to the terms and the user makes the online payment. Once the payment is received by the gateway enabled by the software developer, the application interface generates an invoice, receipt and access credentials that allow the user to fill out the questionnaire form. The consultant receives the payment, and engages self or level-3 user to evaluate the form submitted by user. User takes the survey and fills the questionnaire form after level 3 completes the filing questionnaire form the level-2 user comments on the response of the questionnaire form and forward to the top level. After user comments the workflow is passed to the consultant level-3. The received from level-3 workflow passes with comments to level-2 of consultant level-2 comments and forwards to top level of the consultant. The consultant generates and shares the final report with the pre-paid user.

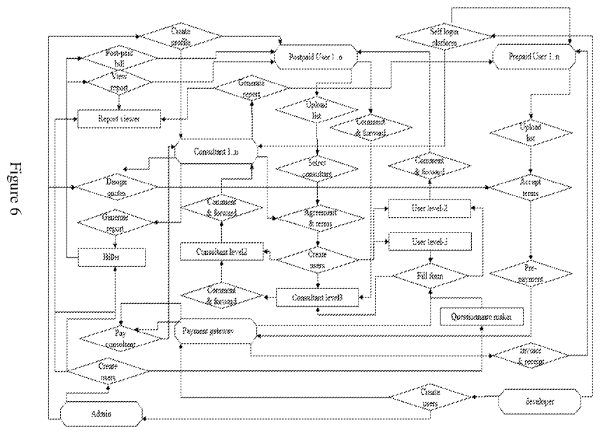

FIG. 6 illustrates an exemplary flow chart of the system for finding a tariff code in accordance with another embodiment of the present disclosure. FIG. 6 describes the functionality of the system for finding a tariff code, wherein includes non-user, pre-paid-user, and post-paid-user. The system for finding a tariff code includes Admin module, User module, Pre-paid user, Post-paid user, Consultant module, and Biller module.

Admin module: The admin gets login credentials from software developer, who hosts the software on cloud.

The Admin creates the roles for ‘Questionnaire maker’, ‘Biller’ & ‘Report viewer’. Admin also approves user and till the self-login module is ready, the Admin shall create Customer and Consultant profiles, as well.

User module: The execution process of the user starts once the online agreement is entered into by the user, after which a user id and a password would be made available to the user through which, the further steps would be completed by the user through the web interface that has been created to implement.

Once the user has logged in using the credentials that have been allotted, through the help of the questionnaires that have been provided and the user answers with the best possible choice out of the options, after which the questions would be narrowed down to zero in on the appropriate classification for the goods. Once the appropriate classification has been generated, the user has an option to forward the report to others in the company or print the report. The user module is designed to administer post-paid as well as pre-paid users.

Post-paid user: This module is designed to provide 2 additional levels, if needed by the post-paid user. The ‘product list’ must be appended at the top level and the work allotted among the lower levels. The 3^{rd} level shall undertake the questionnaires and the 2^{nd} level is enabled to give comments. The top level shall finalize user submission which upon submission shall reflect as a workflow at the selected Consultant's dashboard.

Prepaid user: This module shall be activated when the Payment Gateway interface is in place. An online user from any location on the globe shall be able to self-login and obtain a quote after supplying information about a product(s). Upon making payment the user is enabled to undertake the questionnaires and submit information about the products.

Consultant module: The consultant module is currently proposed at three tiers by adding two more levels in the flow, if needed by the consultant. The product information supplied by a user first gets shown at the dashboard of the 3^{rd} level consultant who shall examine and submit it. The workflow would next show up at the 2^{nd} level of a consultant whose expertise may require alterations on the opinion of the 3^{rd} level consultant. After the 2^{nd} level consultant completes the editing, the workflow passes to top level consultant who shall finalize the opinion about the classification.

The consultant module is designed to onboard a post-paid user. The post-paid user is allowed to get to onboard 2 more levels. The questionnaires form is actually filled at the 3^{rd} level and the second and top levels get to examine the facts submitted at the 3^{rd} level. The submission of information must be finalized by the final level, after which the workflow passes on to the selected consultant's module at the 3^{rd} level.

It is upon the judgment of the Consultant, whether the product information needs a deeper look or not depending on the complexity of the items, after which a draft opinion may be shared with the user. Based on additional information supplied, the decision process for the desirable HS code would be taken out of the website.

Biller module: The Biller raises invoices and follows recoveries.

An exemplified pseudo-code depicting the execution of various modules of system 100 a tariff code finder is given below:

```
  Class Code_Finder
  {
  Server( )
  {
  Framwork( )
  {
  F= including a questionnaire form, a user profile, a company profile,
and an enquiry form;
  }
  Repository( )
  {
  R= store a list of at least one pre-stored question, user details, and the
question for the questionnaire form;}
  }
  User_Interface( )
  {
  Call.Server( );
  UI=receive user inputs from a user application running on a computing
  device of a user;
  }
  Admin_Interface( )
  {
  Call.Server( );
  AI=manage and validate a company account, a user account, and the
questionnaire form based on the user inputs, and generate login credentials
for the user;
  }
  Input_Module( );
  {
  Call. Server( );
  Call.User_Interface( );
  Call. Admin_Interface( );
  If (User Registered = = True)
  {
  System.out.println(“enable the user to log into an account using the
  login credentials”, & enable);
  } else{
  System.out.println(“User not registered”);
  }
  }
  Input_Module( )
  {
  Call. Login_Module( );
  System.out.println(“User login successful”);
  Do (submit form)
  {
  Fill out the Enquiry form and Submit form;}
  While (Select the Enquiry Form)
  }
  Crawler_and_Extractor_Module( )
  {
  Call.Repository( );
  Call. Input_Module( );
  For (Q=1; Q<= N; Q++)
  {
  System.out.println(“extract the questions”); // crawl through a list of
  questions;
  }
  }
  Display_Module( )
  {
  Call.Crawler_and_Extractor_Module( );
  Call.Input_Module( );
  System.out.println(“display at least one response pertaining to each of
the extracted questions”);
  }
  Response_Analyzer( )
  {
  Call.Display_Module( );
  analyze the response provided by the user;
  select a next question based on the response, and
  prompt the user to upload a relevant media;
  }
  Uploading Module( )
  {
  Call Response_Analyzer( );
  upload the relevant media;
  HS_code_generator( );
  Call.Uploading Module( );
  generate the HS code with information;
  }
  }
```

In an operative configuration, the server 102 implements a web-based platform having the framework 102a and the repository 102b. The framework 102a includes a questionnaire form, a user profile, a company profile, and an enquiry form. The repository 102b stores a list of at least one pre-stored question, user details, and the list of the questionnaire. The user interface 104 is configured to receive user inputs from a user application running on a computing device of a user. The admin interface 106 is configured to manage and validate a company account, a user account, and the questionnaire form based on the user inputs, and to generate login credentials for the user. The login module 108 enables the user to log in to an account using the login credentials. The input module 110 is configured to cooperate with the login module 108 to allow the user to select an enquiry form to fill in the details about goods and submit the enquiry form. The crawler and extractor module 112 is configured to cooperate with the input module 110 to crawl through a list of questions stored in the repository 102b and extract the questions based on the enquiry form selected by the user. The display module 114 is configured to cooperate with the crawler and extractor module 112 and the input module 110 to display at least one response pertaining to each of the extracted questions on the user interface 104. The response analyzer 116 is configured to analyze the responses provided by the user, select a set of next questions from repository 102b based on the responses for receiving further responses from the user, or prompt the user to upload a relevant media. The uploading module 118 is configured to cooperate with the response analyzer 116 to upload the relevant media, including relevant text, product literature, and a photo of the packaging, of a good for which a Harmonized System (HS) code is to be retrieved from the repository 102b. The HS code finder 120 is configured to cooperate with the uploading module 118 and the response analyzer 116 to find the HS code with information based on the responses provided by the user and the relevant media uploaded by the user.

Below are the disadvantages that the system (100) proposed herein overcomes:
The precise information required may not get captured or called: The information gathered requires interaction between technical and commercial people within the organization. Defining requisite criteria and receiving precise information may not happen as desired.
The subjectivity of classification to the parameters other than description may get ignored: Goods are usually described in a variety of names and if the user is not familiarized with the entire HS or the nation's tariff he may not reach up to the specific codes. Further, the description alone may not be the only factor based on which classification can be determined. However, the methods that rely on description alone can ignore the number of such factors and lead to the wrong conclusion.
May not give the appropriate result: The majority of methods presently followed lack the scientific approach hence, the conclusions drawn can be wrong
Different HS classification of same goods: Different persons may follow a different methodology to determine the classification. In such a case classification of the same goods could differ. At multiple locations, this can go neglected for some time.
Lack of expertise & shortage of experts: When a business comes up with a new product, they are required to determine the classification code for the new item they may not find required expertise.
Lack of desired speed: The scientific method of taking advice from an expert is time-consuming as it requires precise information to be obtained from the stakeholders of different teams i.e., the technical team and commercial team. Frequently bringing both teams to the same table is quite challenging and therefore it becomes time-consuming. It does not address the issue within desired time limits put in by the users or statutory authorities.
Cost intensive: Developing an in-house team calls for access to all relevant information available on various subscription-based websites, knowledge portals, and in books & periodicals. This could be very costly for a single organization. For example, the price of the latest physical edition of explanatory notes issued by the WCO cost Rupees 1,25,000/-in 2018. The cost of fees charged by the third-party experts as well is very high.
Preservation of conclusion on classification over longer duration: The conclusions are drawn and the basis may not get retained due to attrition of key persons of a given organization and it may not get offered as a defense in case of any challenge from the statutory authorities. Further, it is also possible that the conclusions are not followed across the board as implementation in ERP is another task.
The rate of tax drives the classification: The persons responsible or the organizations may get prejudiced by lower rates or exemptions. The authorities as well are inclined to charge a higher rate. Further, the same rate as well makes the user ignore the appropriate alternatives.

Further, the online textual searches or the textual search conducted on the downloaded tariff schedules and the table does not help unless the user understands the exact terms in which his product is mentioned in the HS or the tariffs. For example, ‘betel nut’, is covered by the HS under the scientific term ‘areca nut’. So, if a user types ‘betel’ for searching his product in the tariff, the search is unlikely to show a result.

Secondly, even while the user may reach a code that prima facie appears to cover the product under consideration, he may miss out on Chapter/Section Notes that shift the basis of classification from such perceived code for the simple reason that he may just not be aware of the text to continue the further search in the notes.

After all, it must be cautioned that whatever the findings from such searches human judgment is required to arrive at the appropriate classification. So, though the web links help in getting a quick result, one may not completely rely on the same as the basis to form the conclusion is arbitrary and cannot be offered as a defense when authorities object.

The foregoing description of the embodiments has been provided for purposes of illustration and is not intended to limit the scope of the present disclosure. Individual components of a particular embodiment are generally not limited to that particular embodiment but are interchangeable. Such variations are not to be regarded as a departure from the present disclosure, and all such modifications are considered to be within the scope of the present disclosure.

### Technical Advancements

The present disclosure described herein above has several technical advantages including, but not limited to, the realization of a system and a method for finding a tariff code that:
easy to implement;
prevents the time loss and penalties in searching for the correct code;
display the precise information according to the product;
collects information from competent or relevant resources working from home or anywhere;
helps to search for the code as per the country, language, and different name of a particular good;
helps with avoiding the misclassified entry of goods.
provide universal HS-based code cross-language;
avoid cultural barriers while understanding goods, cargo, merchandise, supplies, products, etc.; and
provide different HS classifications for the same goods.

The embodiments herein and the various features and advantageous details thereof are explained with reference to the non-limiting embodiments in the following description. Descriptions of well-known components and processing techniques are omitted to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The foregoing description of the specific embodiments so fully reveals the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

The use of the expression “at least” or “at least one” suggests the use of one or more elements or ingredients or quantities, as the use may be in the embodiment of the disclosure to achieve one or more of the desired objects or results.

While considerable emphasis has been placed herein on the components and parts of the preferred embodiments, it will be appreciated that many embodiments can be made and that many changes can be made in the preferred embodiments without departing from the principles of the disclosure. These and other changes in the preferred embodiment as well as other embodiments of the disclosure will be apparent to those skilled in the art from the disclosure herein, whereby it is to be distinctly understood that the foregoing descriptive matter is to be interpreted merely as illustrative of the disclosure and not as a limitation.

1. A system (100) for finding a tariff code, comprising:
a server (102) implementing a web-based platform having a framework (102a) and a repository (102b), wherein the framework (102a) includes a questionnaire form, a user profile, a company profile, and an enquiry form, wherein the server (102) includes:
a user interface (104) configured to receive user inputs from a user application running on a computing device of a user;
an admin interface (106) configured to manage and validate a user account and related questionnaire form based on the user inputs, and configured to generate login credentials for the user;
a login module (108) configured to enable the user to login into the user account using the login credentials;
an input module (110) configured to cooperate with the login module (108) to allow the user to select an enquiry form through an interface of the user account and submit the enquiry form;
a crawler and extractor module (112) configured to cooperate with the input module (110) to crawl through a list of questions stored in said repository (102b) and extract the questions from said repository (102b) based on the enquiry form selected by the user;
a display module (114) configured to cooperate with the crawler and extractor module (112) and the input module (110) to display at least one response pertaining to each of the extracted questions on the user interface (104);
a response analyzer (116) configured to analyze the responses provided by the user for the extracted questions, select a next set of questions from said repository (102b) based on the responses for receiving further responses from the user, or prompt the user to upload a relevant media;
an uploading module (118) configured to cooperate with the response analyzer (116) to upload the relevant media, including relevant text, product literature, and a photo of the packaging, of a good for which a Harmonized System (HS) code is to be retrieved from said repository (102b); and
an HS code finder (120) configured to cooperate with the uploading module (118) and with said response analyzer (116) to find the HS code with information based on the responses provided by the user and the relevant media uploaded by the user.

2. The system (100) as claimed in claim 1, wherein the framework (102) includes:
a user module configured to manage an account login control, a user profile edit, designations, user details, the questionnaire form, a report generator, a report viewer, consultant details, a payment gateway, and agreement and terms, and
an admin module configured to manage an account login control, a user account, designations, the questionnaire form, a questionnaire maker, a report generator, consultant details, a biller, a payment gateway, an agreement, and a terms maker.

3. The system (100) as claimed in claim 1, wherein the computing device of the user is a device selected from one of a mobile device, a laptop, a tablet, or a desktop system.

4. The system (100) as claimed in claim 1, wherein the repository (102b) is configured to store a list of at least one set of pre-stored questions, user details, and the questions for the questionnaire form.

5. The system (100) as claimed in claim 1, wherein the questionnaire form selects a questionnaire from the set of a questionnaire consisting of a multiple-choice question, a single response question, and a set of questions and sub-questions.

6. The system (100) as claimed in claim 1, wherein the system (100) continues the analyses of the responses and the uploaded relevant media till a correct HS code is found in said repository (102b) and displayed on said display module (104).

7. A method (200) for finding a tariff code, wherein the method (200) is being carried out by a server (102) implementing a web-based platform having the framework (102a) and repository (102b), wherein the framework (102a) has questioner form, user profile, company profile, and enquiry form, and wherein the method comprising the following steps:
receiving, by a user interface (104), user inputs from a user application running on a computing device of a user;
managing, by an admin interface (106), a user account and a questionnaire form based on the user inputs;
validating, by said admin interface (106), the user account and the questionnaire form based on the user inputs for generating login credentials for the user;
enabling, by a login module (108), the user to login into an account using the login credentials;
receiving, by an input module (110), an input from the user select and submit an enquiry form through an interface of the user account;
crawling, by a crawler and extractor (112), through a list of questions stored in said repository (102b) and extracting the questions from said repository (102b) based on the enquiry selected by the user,
displaying, by a display module (114), at least one response pertaining to each of the extracted questions on the user interface (104),
analyzing, by a response analyzer (116), the responses provided by the user for the extracted questions, select the next set of questions from said repository (102b) based on the responses for receiving further responses from the user, or prompt the user to upload a relevant media,
uploading, by an uploading module (118), the relevant media, including a relevant text, product literature, and a photo of the packaging, of a good for which a Harmonized System (HS) code is to be retrieved from said repository (102b); and
finding, by a code finder (120), the HS code with information based on the responses provided by the user and the relevant media uploaded by the user.
